(19) United States
(12) Patent Application Publication
(10) Pub. No.: US 2026/0360922 A1
(43) Pub. Date: Nov. 12, 2026

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Yeon Ho LEE, Suwon-si (KR); Ae Hui GOH, Suwon-si (KR); Min Ji SIM, Suwon-si (KR); Jung In MUN, Suwon-si (KR); Won Jun JO, Suwon-si (KR); Myung heui WOO, Suwon-si (KR)

(73) Assignee: SAMSUNG SDI CO., LTD., Yongin-si (KR)

(21) Appl. No.: 19/646,662

(22) Filed: Apr. 14, 2026

(30) Foreign Application Priority Data
Apr. 28, 2025 (KR) 10-2025-0055071

(51) Int. Cl. H01M 50/449; H01M 10/0525; H01M 50/42; H01M 50/423; H01M 50/491

(52) U.S. Cl. CPC H01M 50/449; H01M 10/0525; H01M 50/42; H01M 50/423; H01M 50/491

(57) ABSTRACT

The present disclosure relates to a separator for a rechargeable lithium battery, and a rechargeable lithium battery including the separator. The separator for a rechargeable lithium battery includes a porous substrate, and a coating layer positioned on at least one surface of the porous substrate. The coating layer includes a binder and an additive, and the additive includes one or more of a compound, an oligomer thereof, and a polymer thereof.

### CROSS-REFERENCE TO RELATED APPLICATION

The present application claims priority and the benefit of Korean Patent Application No. 10-2025-0055071, filed on Apr. 28, 2025, in the Korean Intellectual Property Office, the entire disclosure of which is incorporated herein by reference.

### BACKGROUND

### 1. Field of the Disclosure

The present disclosure relates to a separator for a rechargeable lithium battery, and a rechargeable lithium battery including the separator.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, research and development for improving the performance of rechargeable lithium batteries is actively being conducted.

A rechargeable lithium battery typically includes a positive electrode and a negative electrode that contain an active material capable of the intercalation and deintercalation of lithium ions, and produces electric energy by oxidation and reduction reactions when the lithium ions are intercalated into and deintercalated from the positive electrode and the negative electrode.

A rechargeable lithium battery may include a separator between the positive electrode and the negative electrode.

### SUMMARY

One example embodiment includes a separator for a rechargeable lithium battery that provides high adhesive strength and low film resistance.

According to another example embodiment, a separator for a rechargeable lithium battery reduces or suppresses ignition upon heat exposure of the battery.

Still another example embodiment includes a rechargeable lithium battery including a positive electrode, a negative electrode, and the separator for a rechargeable battery positioned between the positive electrode and the negative electrode.

According to one example embodiment, there is provided a separator for a rechargeable lithium battery.

The separator for a rechargeable lithium battery includes a porous substrate, and a coating layer positioned on at least one surface of the porous substrate, the coating layer includes a binder and an additive, and the additive includes one or more of a compound of Chemical Formula 1 below, a compound of Chemical Formula 2 below, an oligomer thereof, and a polymer thereof: Chemical Formula 1:

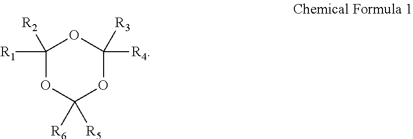

In Chemical Formula 1, each of R₁ to R₆ is as described below.

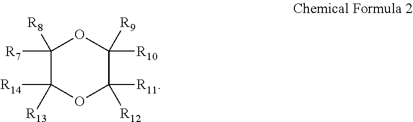

In Chemical Formula 2, each of R₇ to R₁₄ is as described below.

Another example embodiment includes a rechargeable lithium battery.

The rechargeable lithium battery includes a positive electrode, a negative electrode, and a separator for a rechargeable lithium battery positioned between the positive electrode and the negative electrode.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which: FIG. 1 is a cross-sectional view illustrating a separator for a rechargeable lithium battery according to one example embodiment.

FIG. 2 is a cross-sectional view illustrating a separator for a rechargeable lithium battery according to another example embodiment.

FIG. 3 is a cross-sectional view illustrating a separator for a rechargeable lithium battery according to still another example embodiment.

FIG. 4 to FIG. 7 are cross-sectional views schematically illustrating a rechargeable lithium battery according to one example embodiment.

### DETAILED DESCRIPTION

Hereinafter, example embodiments of the present disclosure may be described in detail. However, the embodiments are provided as examples, the present disclosure is not limited thereto, and the present disclosure is only defined by the scope of the claims to be described below.

Unless otherwise specified herein, when a part such as a layer, film, region, plate, and the like, is described as being “on” another part, it includes not only the case where the part is “directly on” the other part but also the case where there is another part present therebetween.

Unless otherwise specified in this specification, anything indicated in the singular may also include the plural. Further, unless otherwise stated, “A or B” may mean “including A, including B, or including A and B.” As used herein, the term “a combination thereof” may mean a mixture, laminate, composite, copolymer, alloy, blend, and reaction product of the components.

Here, the term “particle diameter D50” refers to the average particle diameter, which means the diameter of particles with a cumulative volume of 50% by volume in the particle size distribution. The particle size distribution may be measured by methods well known to those skilled in the art. For example, the particle size distribution may be measured using a particle size analyzer, a transmission electron micrograph, or a scanning electron micrograph.

In another method, an D50 value may be obtained by measuring the particle diameter using a measuring device using dynamic light scattering, performing data analysis to count the number of particles for each particle size range, and then calculating the particle diameter therefrom.

Alternatively, D50 may be measured using a laser diffraction method. For example, when measuring by laser diffraction, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the D50 based on 50% by volume of the particle diameter distribution in the measurement device may be calculated.

In this specification, “(meth)acrylic” means acrylic and/or methacrylic.

Unless otherwise defined herein, “substitution” means that hydrogen in a compound is replaced by a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br or I), a hydroxyl group (—OH), a nitro group (—NO₂), a cyano group (—CN), an amino group (—NRR′) (wherein, R and R′ are each independently hydrogen or a C1 to C6 alkyl group), a sulfobetaine group (—RR′N⁺(CH₂)nSO₃⁻, n is a natural number in a range from 1 to 10), a carboxybetaine group (—RR′N⁺(CH₂)ₙCOO⁻, n is a natural number in a range from 1 to 10) (wherein, R and R′ are each independently a C1 to C20 alkyl group), an azido group (—N₃), an amidino group (—C(═NH)NH₂), a hydrazino group (—NHNH₂), a hydrazono group (═N(NH₂), a carbamoyl group (—C(O)NH₂), a thiol group (—SH), an acyl group (—C(═O)R, where R is hydrogen, a C1 to C6 alkyl group, a C1 to C6 alkoxy group, or a C6 to C12 aryl group), a carboxyl group (—COOH) or a salt thereof (—C(═O)OM, where M is an organic or inorganic cation), a sulfonic acid group (—SO₃H) or a salt thereof (—SO₃M, where M is an organic or inorganic cation), a phosphate group (—PO₃H₂) or a salt thereof (—PO₃MH or —PO₃M₂, where M is an organic or inorganic cation), and combinations thereof.

Hereinafter, a C1 to C3 alkyl group means a methyl group, an ethyl group, or a propyl group. A C1 to C10 alkylene group may be, for example, a C1 to C6 alkylene group, a C1 to C5 alkylene group, or a C1 to C3 alkylene group, such as a methylene group, an ethylene group, or a propylene group. A C3 to C20 cycloalkylene group may be, for example, a C3 to C10 cycloalkylene group or a C5 to C10 cycloalkylene group, such as a cyclohexylene group. A C6 to C20 arylene group may be, for example, a C6 to C10 arylene group, such as a phenylene group. A C3 to C20 heterocyclic group may be, for example, a C3 to C10 heterocyclic group, such as a pyridine group.

Hereinafter, “hetero” means including one or more heteroatoms such as or including at least one of N, O, S, Si, and P.

In chemical formulas, the * symbol indicates a moiety that is connected to the same or different atoms, groups, or structural units. Unless otherwise specifically stated in the chemical formulas described herein, it may be assumed that hydrogen is bonded in the structure of the chemical formula.

Hereinafter, “alkali metal” refers to an element belonging to Group 1 of the periodic table, such as lithium, sodium, potassium, rubidium, cesium, or francium and may be present in a cationic or neutral state.

When describing a numerical range in this specification, ‘X to Y’ means ‘X or more and Y or less (X≤ and ≤Y).’

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to one example embodiment, the separator for a rechargeable lithium battery can provide high adhesive strength. For example, the separator can provide high wet adhesive strength to both a positive electrode and a negative electrode. Accordingly, the separator can provide a low thermal shrinkage rate, a long room-temperature lifetime, and a long high-temperature lifetime. In particular, the separator can increase the reliability of a battery by providing a low thermal shrinkage rate even when the battery is allowed to stand at a high temperature after room-temperature lifetime evaluation.

According to one example embodiment, the separator for a rechargeable lithium battery can provide a long room-temperature lifetime and a long high-temperature lifetime by providing a low membrane resistance (e.g., electrochemical impedance spectroscopy (EIS) membrane resistance).

According to one example embodiment, the separator for a rechargeable lithium battery can improve the safety and reliability of a battery by reducing or suppressing ignition upon heat exposure of the battery having the separator.

According to one example embodiment, the separator includes a porous substrate and a coating layer positioned on at least one surface of the porous substrate, the coating layer includes a binder and an additive, and the additive includes one or more of a compound of Chemical Formula 1 below, a compound of Chemical Formula 2 below, an oligomer thereof, and a polymer thereof.

Each of the compound of Chemical Formula 1 below, the compound of Chemical Formula 2 below, the oligomer, and the polymer can simultaneously or contemporaneously provide high adhesive strength and low membrane resistance effects.

The compound of Chemical Formula 1, the compound of Chemical Formula 2, the oligomer, and the polymer can increase the bonding strength of the coating layer by being included in the coating layer together with the binder and/or filler described below, thereby providing high adhesive strength. Each of the compound of Chemical Formula 1 below, the compound of Chemical Formula 2 below, the oligomer, and the polymer has a polyoxyalkylene, for example, polyoxymethylene, and thus is expected to interact (e.g., hydrogen bonding) with the binder and/or filler described below, thereby exhibiting the effect of increasing the bonding strength, but the present disclosure is not limited thereto.

Each of the compound of Chemical Formula 1 below, the compound of Chemical Formula 2 below, the oligomer, and the polymer is expected to increase the ion conductivity of the separator, thereby providing a low membrane resistance, but the present disclosure is not limited thereto. In one example, the oligomer and the polymer can have a superior membrane resistance reduction effect to each of the compound of Chemical Formula 1 and the compound of Chemical Formula 2.

The compound of Chemical Formula 1 is represented by Chemical Formula 1 below:

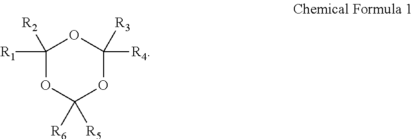

In Chemical Formula 1, R₁ to R₆ are each independently a hydrogen atom or a substituted or unsubstituted C1 to C10 alkyl group.

For example, in Chemical Formula 1, all of R₁ to R₆ may independently be a C1 to C10 alkyl group. For example, in Chemical Formula 1, all of R₁ to R₆ may independently be a hydrogen atom. For example, in Chemical Formula 1, at least one of R₁ to R₆ may be or include a C1 to C10 alkyl group, and at least one of R₁ to R₆ may be a hydrogen atom. For example, in Chemical Formula 1, at least one of R₁ to R₆ may be hydrogen.

The compound of Chemical Formula 1 may include 1,3,5-trioxane (TRX) represented by Chemical Formula 1-1 below:

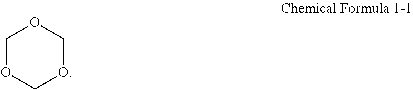

The compound of Chemical Formula 1 may include at least one of a compound represented by Chemical Formula 1-2 below, a compound represented by Chemical Formula 1-3 below, a compound represented by Chemical Formula 1-4 below, or any combination thereof:

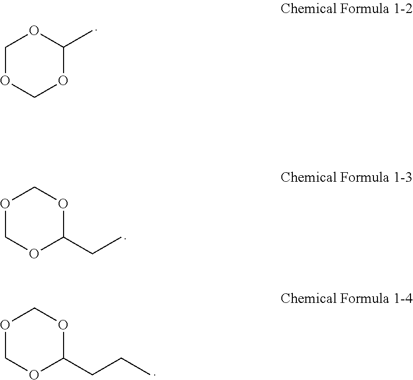

In one example, the oligomer and the polymer may each be formed by a ring-opening reaction of the compound of Chemical Formula 1. The ring-opening reaction may be performed by heating the compound of Chemical Formula 1. The heating may be provided by drying and/or aging during the manufacturing process of the coating layer, heat generation within a battery, and the like. In one example, the oligomer and the polymer may each include polyoxymethylene as a repeating unit. The formation of a polyoxymethylene oligomer and a polyoxymethylene polymer by the ring-opening reaction of TRX is well known.

Here, the oligomer may refer to a substance having a lower weight average molecular weight compared to the polymer.

The compound of Chemical Formula 2 is represented by Chemical Formula 2 below:

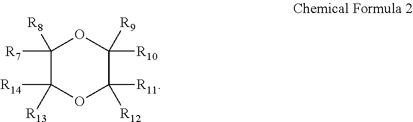

In Chemical Formula 2, R₇ to R₁₄ are each independently a hydrogen atom or a substituted or unsubstituted C1 to C10 alkyl group.

For example, in Chemical Formula 2, all of R₇ to R₁₄ may independently be or include a C1 to C10 alkyl group. For example, in Chemical Formula 2, all of R₇ to R₁₄ may be independently a hydrogen atom. For example, in Chemical Formula 2, at least one of R₇ to R₁₄ may be or include a C1 to C10 alkyl group, and at least one of R₇ to R₁₄ may be a hydrogen atom.

The compound of Chemical Formula 2 may include 1,4-dioxane represented by the following Chemical Formula 2-1:

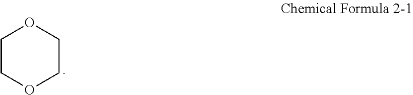

The compound of Chemical Formula 2 may include at least one of a compound represented by Chemical Formula 2-2 below, a compound represented by Chemical Formula 2-3 below, a compound represented by Chemical Formula 2-4 below, or any combination thereof:

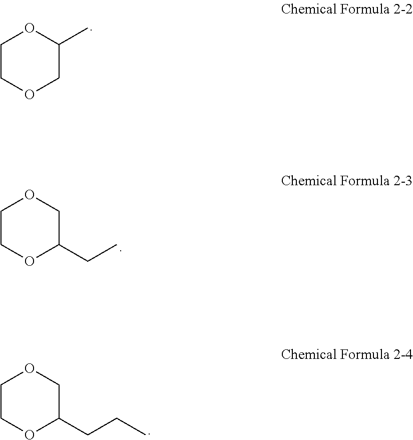

In one example, the oligomer and the polymer may each be formed by a ring-opening reaction of the compound of Chemical Formula 2. The ring-opening reaction may be performed by heating the compound of Chemical Formula 2. The heating may be provided by drying and/or aging during the manufacturing process of the coating layer, heat generation within a battery, and the like. In one example, the oligomer and the polymer may each include polyoxymethylene as a repeating unit.

One or more of the compound of Chemical Formula 1, the compound of Chemical Formula 2, the oligomer, and the polymer may be included in the coating layer in an amount in a range of about 0.01% to about 10% by weight, for example, 0.1% to 5% by weight. In the above-described range, the effect of providing high adhesive strength and low membrane resistance of the separator may be enhanced.

For example, the coating layer may include one or more of the compound of Chemical Formula 1, the oligomer of the compound of Chemical Formula 1, and the polymer of the compound of Chemical Formula 1.

The additive may be included at any position in the coating layer. In one example, the additive may be included at the interface between the coating layer and the porous substrate, included on the outermost surface of the coating layer, and/or included inside the coating layer. For example, the additive may be included inside the coating layer to increase the degree of interaction between the binder and/or the filler, thereby enhancing the effect of improving the adhesive strength of the separator.

The binder may include one or more of a heat-resistant binder and an adhesive binder.

Heat-resistant binder:

The heat-resistant binder can further increase the high-temperature lifetime of the battery by further lowering the thermal shrinkage rate of the separator.

The heat-resistant binder may be or include a water-based (meth)acrylic binder.

The heat-resistant binder may have a functional group that interacts with the additive. The functional group may be or include one or more of a hydroxyl group, an amide group, a carboxylic acid group, a cyano group, a sulfonic acid group, a sulfonic acid salt group, and a sulfonate group. For example, the functional group may be an amide group. The amide group may have a high degree of hydrogen bonding with the additive, thereby increasing the effect of the separator.

The heat-resistant binder may include one or more of a structural unit derived from (meth)acrylate or (meth)acrylic acid, a structural unit containing a cyano group, a structural unit derived from (meth)acrylamide, and a structural unit containing a sulfonic acid group, a sulfonic acid salt group, or a sulfonate group.

In one example, the heat-resistant binder may have a structural unit derived from (meth)acrylamide, and a structural unit containing a sulfonic acid group, a sulfonic acid salt group, or a sulfonate group. In another example, the heat-resistant binder may have a structural unit derived from (meth)acrylamide, a structural unit containing a sulfonate group, and a structural unit derived from (meth)acrylate or (meth)acrylic acid.

The structural unit containing a sulfonate group may be included in the (meth)acrylic binder in an amount in a range of about 0.1% to about 60% by mol, for example, 0.1% to 20% by mol, 0.1% to 10% by mol, 1% to 20% by mol, for example, 1% to 10% by mol, for example, 20% to 65% by mol, 30% to 65% by mol. When a structural unit containing a sulfonate group is included in the above-described range, the separator can exhibit desired or improved adhesive strength, heat resistance, air permeability, and oxidation resistance.

The structural unit derived from (meth)acrylate or (meth)acrylic acid may be included in the (meth)acrylic binder in an amount in a range of about 0% to about 70% by mol, for example, 10% to 70% by mol, 10% to 60% by mol, 20% to 60%, by mol, 10% to 50% by mol, 30% to 60% by mol, 10% to 40% by mol, or 40% to 55% by mol. In the above-described range, the separator can exhibit desired or improved adhesive strength, heat resistance, air permeability, and oxidation resistance.

The structural unit containing a cyano group may be included in the (meth)acrylic binder in an amount in a range of about 0% to about 85% by mol, for example, 30% to 85% by mol, 30% to 70% by mol, 30% to 60% by mol, 35% to 60% by mol, or 35% to 55% by mol. In the above-described range, the separator can secure desired or improved oxidation resistance and exhibit adhesive strength, heat resistance, and air permeability.

The structural unit derived from (meth)acryl amide may be included in the (meth)acrylic binder in an amount in a range of about 0% to about 95% by mol, for example, 40% to 85% by mol, 50% to 85% by mol, 55% to 95% by mol, 60% to 85% by mol, 75% to 95% by mol, or 80% to 95% by mol. In the above-described range, the separator can secure desired or improved oxidation resistance and exhibit adhesive strength, heat resistance, and air permeability.

According to one example embodiment, the (meth)acrylic binder may have, for example, a range of about 0.1% to about 30% by mol, for example, 0.1% to 10% by mol of the structural unit containing a sulfonate group, for example, a range of about 10% to about 60% by mol, for example, 10% to 40% by mol of the structural unit derived from (meth)acrylate or (meth)acrylic acid, and for example, a range of about 30% to about 85% by mol, for example, 30% to 80% by mol of the structural unit containing a cyano group. In one example, the sum total of the structural unit containing a sulfonate group, the structural unit derived from (meth)acrylate or (meth)acrylic acid, and the structural unit containing a cyano group may be about 95% by mol or more, for example, in a range of about 95% to about 100% by mol or 100% by mol based on 100% by mol of the (meth)acrylic binder.

According to another example embodiment, the (meth)acrylic binder may have, for example, in a range of about 1% to about 20% by mol, for example, 5% to 20% by mol of the structural unit containing a sulfonate group, and, for example, in a range of about 80% to about 99% by mol, for example, 80% to 95% by mol of the structural unit derived from (meth)acrylamide. In one example, the sum total of the structural unit containing a sulfonate group and the structural unit derived from (meth)acrylamide may be about 95% by mol or more, for example, in a range of about 95% to about 100% by mol, or 100% by mol, based on 100% by mol of the (meth)acrylic binder.

According to still another example embodiment, the (meth)acrylic binder may have a structural unit containing a sulfonate group, a structural unit derived from (meth)acrylate or (meth)acrylic acid, and a structural unit derived from (meth)acryl amide. In one example, the sum total of the structural unit containing a sulfonate group, the structural unit derived from (meth)acrylate or (meth)acrylic acid, and the structural unit derived from (meth)acryl amide may be about 95% by mol or more, for example, in a range of about 95% to about 100% by mol, or 100% by mol, based on 100% by mol of the (meth)acrylic binder.

Each structural unit of the (meth)acrylic binder is described in detail.

The structural unit derived from the (meth)acrylate or (meth)acrylic acid may be represented by, for example, at least one of Chemical Formula 3, Chemical Formula 4, or Chemical Formula 5 below, or a combination thereof:

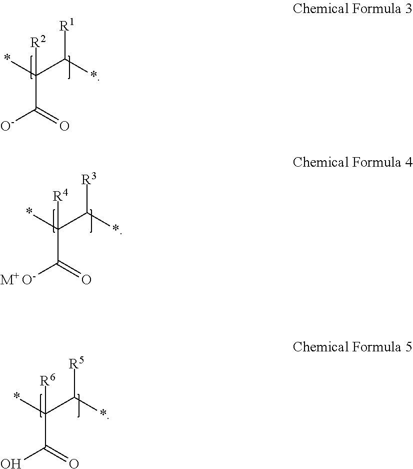

In Chemical Formulas 3 to 5, R¹ to R⁶ are each independently hydrogen or a methyl group, and in Chemical Formula 4, M is or includes an alkali metal. The alkali metal may be or include, for example, at least one of lithium, sodium, potassium, rubidium, or cesium.

For example, the structural unit derived from (meth)acrylate or (meth)acrylic acid may include a structural unit represented by Chemical Formula 4 and a structural unit represented by Chemical Formula 5, and in this case, the structural unit represented by Chemical Formula 4 and the structural unit represented by Chemical Formula 5 may be included in a molar ratio in a range of about 10:1 to about 1:2, or 10:1 to 1:1, or 5:1 to 1:1.

The structural unit containing a cyano group may be represented, for example, by Chemical Formula 6 below:

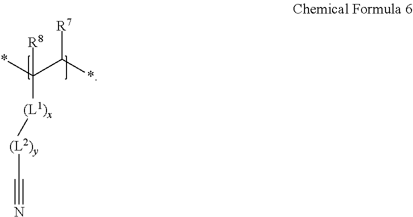

In Chemical Formula 6:
R⁷ and R⁸ are each independently hydrogen or a C1 to C3 alkyl group,
L¹ is or includes —C(═O)—, —C(═O)O—, —OC(═O)—, —O—, or —C(═O)NH—,
x is an integer in a range of 0 to 2,
L² is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
y is an integer in a range of 0 to 2.

The structural unit containing a cyano group may be, for example, derived from (meth)acrylonitrile, an alkene nitrile, a cyanoalkyl (meth)acrylate, or a 2-(vinyloxy)alkane nitrile. Here, the alkene may be or include a C2 to C20 alkene, a C2 to C10 alkene, or a C2 to C6 alkene, the alkyl may be or include a C1 to C20 alkyl, a C1 to C10 alkyl, or a C1 to C6 alkyl, and the alkane may be or include a C1 to C20 alkane, a C1 to C10 alkane, or a C1 to C6 alkane.

The alkene nitrile may be or include, for example, allyl cyanide, 4-pentenenitrile, 3-pentenenitrile, 2-pentenenitrile, or 5-hexenenitrile. The cyanoalkyl (meth)acrylate may be or include, for example, cyanomethyl (meth)acrylate, cyanoethyl (meth)acrylate, cyanopropyl (meth)acrylate, or cyanooctyl (meth)acrylate. The 2-(vinyloxy)alkane nitrile may be or include, for example, 2-(vinyloxy)ethanenitrile or 2-(vinyloxy)propanenitrile.

The structural unit containing a sulfonate group may be or include a structural unit containing a conjugate base of sulfonic acid, a sulfonate salt, sulfonate, or a derivative thereof. For example, the structural unit containing a sulfonate group may be represented by at least one of Chemical Formula 7, Chemical Formula 8, or Chemical Formula 9 below, or a combination thereof.

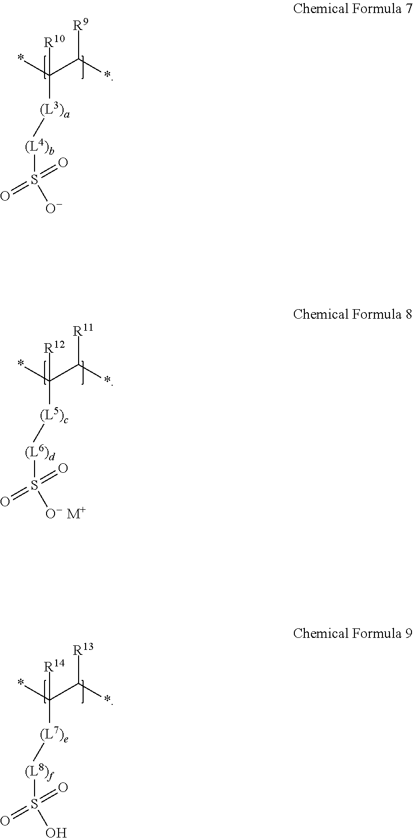

In Chemical Formulas 7 to 9:
R⁹ to R¹⁴ are each independently hydrogen or a C1 to C3 alkyl group,
L³, L⁵, and L⁷ each independently is or includes —C(═O)—, —C(═O)O—, —OC(═O)—, —O—, or —C(═O)NH—,
L⁴, L⁶, and L⁸ each independently is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
a, b, c, d, e, and f are each independently an integer in a range of 0 to 2, and
in Chemical Formula 8,
M is or includes an alkali metal.

For example, in Chemical Formulas 7 to 9:
L³, L⁵, and L⁷ each independently is or includes —C(═O)NH—,
L⁴, L⁶, and L⁸ each independently is or includes C1 to C10 alkylene groups,
and a, b, c, d, e, and f may be an integer equal to 1.

The structural unit containing a sulfonate group may be, for example, derived from vinyl sulfonic acid, allyl sulfonic acid, styrene sulfonic acid, anethole sulfonic acid, a (meth)acrylamidoalkane sulfonic acid, a sulfoalkyl (meth)acrylate, or a salt thereof. Here, the alkane may be or include a C1 to C20 alkane, a C1 to C10 alkane, or a C1 to C6 alkane, and the alkyl may be or include a C1 to C20 alkyl, a C1 to C1O alkyl, or a C1 to C6 alkyl. The salt is composed of or include the above-described sulfonic acid and a suitable ion. The ion may be or include, for example, an alkali metal ion, in which case the salt may be or include a sulfonic acid alkali metal salt.

The (meth)acrylamidoalkane sulfonic acid may be or include, for example, at least one of 2-(meth)acrylamido-2-methylpropane sulfonic acid, and the sulfoalkyl (meth)acrylate may be, for example, 2-sulfoethyl (meth)acrylate, 3-sulfopropyl (meth)acrylate, and the like.

The structural unit derived from (meth)acrylamide may be represented by Chemical Formula 10.

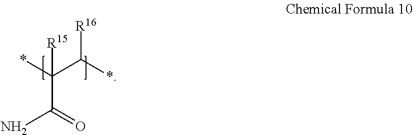

In Chemical Formula 10:
R¹⁵ and R¹⁶ are each independently hydrogen or a methyl group.

The (meth)acrylic binder may include an alkali metal. The alkali metal may be present in the form of a cation, and may be or include, for example, lithium, sodium, potassium, rubidium, or cesium. For example, the alkali metal may be combined with the (meth)acrylic binder and present in the form of a salt. The alkali metal may assist in the synthesis of the (meth)acrylic binder in an aqueous solvent, may enhance the adhesive strength of the coating layer, and may improve the heat resistance, air permeability, and oxidation resistance of the separator.

The alkali metal may be included in an amount in a range of about 1% to about 40% by weight between the alkali metal and the (meth)acrylic binder, and for example, may be included in an amount of 1% to 30% by weight, or 1% to 20% by weight, or 10% to 20% by weight. For example, the (meth)acrylic binder and the alkali metal may be included in a weight ratio in a range of about 99:1 to about 60:40, or a weight ratio of 99:1 to 70:30, for example, a weight ratio of 99:1 to 80:20, for example, a weight ratio of 90:10 to 80:20.

In addition, the alkali metal may be included in an amount in a range of about 0.1% to about 1.0% by mol based on the total content of the alkali metal and the (meth)acrylic binder. When the alkali metal is included in the above-described range, the coating layer can have desired or improved adhesive strength, and the separator including the same can exhibit desired or improved heat resistance, air permeability, and oxidation resistance.

The (meth)acrylic binder may have various forms, such as an alternating copolymer in which the structural units are alternately distributed, a random polymer in which the structural units are randomly distributed, or a graft polymer in which some of the structural units are grafted.

The weight average molecular weight (Mw) of the (meth)acrylic binder may be in a range of about 200,000 g/mol to about 700,000 g/mol, for example, 200,000 g/mol to 600,000 g/mol or 300,000 g/mol to 600,000 g/mol. In the above-described range, the separator can exhibit desired or improved adhesive strength, heat resistance, air permeability, and oxidation resistance. The weight average molecular weight herein may be a polystyrene-converted average molecular weight measured using gel permeation chromatography.

The above (meth)acrylic binder may have a glass transition temperature in a range of about 200 °C to about 280 °C, for example, 210 °C to 270 °C or 210 °C to 260 °C. In the above-described range, the separator can exhibit desired or improved adhesive strength, heat resistance, air permeability, and oxidation resistance. The glass transition temperature may be measured by, e.g., differential scanning calorimetry.

The (meth)acrylic binder may have a melting point (Tm) of about 160 °C or higher.

The (meth)acrylic binder may be prepared by a solution polymerization method.

According to one example embodiment, the (meth)acrylic binder may be included in the coating layer of a separator in the form of a film.

### Adhesive Binder:

The adhesive binder can increase the adhesive strength of the separator, thereby increasing the room-temperature lifetime and high-temperature lifetime of batteries.

The adhesive binder may be an aqueous adhesive binder.

The adhesive binder may have a functional group that interacts with the additive. The functional group may be or include one or more of a hydroxyl group, an amide group, a carboxylic acid group, a cyano group, a sulfonic acid group, a sulfonic acid salt group, and a sulfonate group. For example, the functional group may be or include one or more of a hydroxyl group and a carboxylic acid group. The hydroxyl group and the carboxylic acid group may have a high degree of hydrogen bonding with the additive, thereby increasing the effect of improving the adhesive strength of the separator.

In one example, the adhesive binder may include one or more of polyvinyl alcohol, polyacrylic acid, and a polyvinyl alcohol-polyacrylic acid copolymer. One or more of polyvinyl alcohol, polyacrylic acid, and a polyvinyl alcohol-polyacrylic acid copolymer can significantly increase the effect of improving the adhesive strength of the separator by having the above-mentioned functional group.

In one example, the adhesive binder may include poly(methyl methacrylate). Poly(methyl methacrylate) does not interact with the additive, but may increase the adhesive strength of the separator. For example, poly(methyl methacrylate) may be or include a particulate aqueous binder.

In one example, the adhesive binder may include poly(methyl methacrylate), and one or more of polyvinyl alcohol, polyacrylic acid, and a polyvinyl alcohol-polyacrylic acid copolymer.

In one example, the adhesive binder may include a range of about 80% to about 99% by weight, for example, 90% to 99% by weight of poly(methyl methacrylate), and a range of about 1% to about 20% by weight, for example, 1% to 10% by weight of one or more of polyvinyl alcohol, polyacrylic acid, and a polyvinyl alcohol-polyacrylic acid copolymer. In the above-described range, the adhesive strength of the separator can be further increased, and the effect of the separator can be further increased when combined with the additive.

### Filler:

The coating layer may further include a filler.

The filler may have a particle size D50 of about 0.7 μm or less. In the above-described range, the separator may readily provide a low thermal shrinkage rate. For example, the filler may have a particle size D50 in a range of about 0.1 μm to about 0.7 μm.

The filler may be or include, for example, an inorganic filler, an organic filler, an organic-inorganic composite filler, or a combination thereof. The inorganic filler may be or include a ceramic material capable of improving heat resistance. The inorganic filler may include, for example, at least one of a metal oxide, a metalloid oxide, a metal fluoride, a metal hydroxide, or a combination thereof. The inorganic filler may include at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof but is not limited thereto. The organic filler may include at least one of an acrylic compound, an imide compound, an amide compound, or a combination thereof but is not limited thereto. The organic filler may have a core-shell structure but is not limited thereto.

The filler may be spherical, plate-shaped, cubic, or amorphous. For example, the filler may be cubic.

In one example, the filler may have a functional group that interacts with the additive (for example, forming a hydrogen bond with the additive). The functional group may be or include one or more of a hydroxyl group, an amide group, a carboxylic acid group, a cyano group, a sulfonic acid group, a sulfonic acid salt group, and a sulfonate group. For example, the functional group may be or include a hydroxyl group. The hydroxyl group may have a high degree of hydrogen bonding with the additive, thereby increasing the effect of the separator. For example, the filler may be boehmite. Boehmite may have a high interaction with the additive by having a hydroxyl group on its surface.

A mixture of the heat-resistant binder and the additive and the filler may be included in a mass ratio in a range of about 1:10 to about 1:50, for example, a mass ratio of 1:15 to 1:30. In the above-described range, the adhesive strength of the separator may increase.

### Structure of Coating Layer:

The coating layer may include the additive, the heat-resistant binder, the adhesive binder, and/or the filler, and the coating layer may have a structure of one or more layers.

In one example, the coating layer may be a single layer, and the single layer may include the heat-resistant binder, the filler, and the additive.

FIG. 1 is a cross-sectional view illustrating a separator according to one example embodiment. Referring to FIG. 1, the separator may include a porous substrate 1 and a coating layer 2 formed on the porous substrate 1, and the coating layer 2 may include a filler 3, a heat-resistant binder 4, and an additive (not shown in FIG. 1).

In one example, the coating layer may include a range of about 80% to about 99% by weight, for example, 90% to 99% by weight, of the filler, and a sum total in a range of about 1% to about 20% by weight, for example, 1% to 10% by weight, of the heat-resistant binder and the additive. In the above-described range, the effect of the separator can be readily implemented.

The heat-resistant binder may be included in the coating layer in an amount in a range of about 0.5% to about 10% by weight, for example, 0.5% to 5% by weight, and the additive may be included in the coating layer in an amount in a range of about 0.2% to about 10% by weight, for example, 0.2% to 5% by weight or 0.2% to 3% by weight. In the above-described range, the effect of the separator can be readily implemented.

In another example, the coating layer may be a double layer, including a first layer including the heat-resistant binder, the filler, and the additive, and a second layer formed on the first layer and including the adhesive binder.

The second layer may further include the additive.

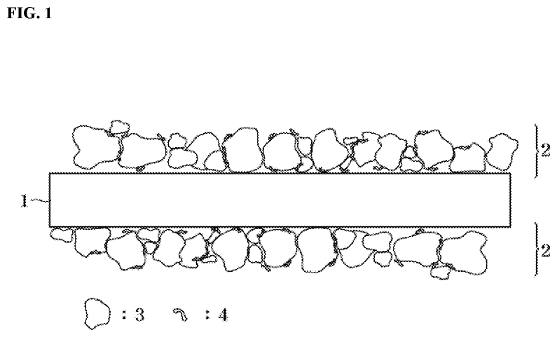

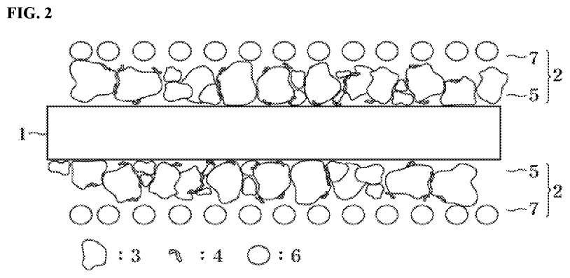

FIG. 2 is a cross-sectional view illustrating a separator according to one example embodiment. Referring to FIG. 2, the separator may include a porous substrate 1 and a coating layer 2 formed on the porous substrate 1, and the coating layer 2 may include: a first layer 5 including a filler 3, a heat-resistant binder 4, and an additive (not shown in FIG. 2); and a second layer 7 including an adhesive binder 6 and an additive (not shown in FIG. 2).

In one example, the first layer may include a range of about 80% to about 99% by weight, for example, 90% to 99% by weight of the filler, and a sum total in a range of about 1% to about 20% by weight, for example, 1% to 10% by weight of the heat-resistant binder and the additive. In the above-described range, the effect of the separator can be readily implemented.

The heat-resistant binder may be included in the first layer in an amount in a range of about 0.5% to about 10% by weight, for example, 0.5% to 5% by weight, and the additive may be included in the first layer in an amount in a range of about 0.2% to about 10% by weight, for example, 0.2% to 5% by weight. In the above-described range, the effect of the separator may be readily implemented.

In one example, the second layer may be or include about 100% by weight of the adhesive binder.

In another example, the second layer may include a range of about 90% to 99.8% by weight, for example, 95% to 99.8% by weight, or 97% to 99.8% by weight, of the adhesive binder, and a range of about 0.2% to 10% by weight, for example, 0.2% to 5% by weight or 0.2% to 3% by weight, of the additive. In the above-described range, the effect of the separator can be readily implemented.

In one example, the second layer may include a range of about 90% to 98% by weight, for example, 90% to 95% by weight, of poly(methyl methacrylate), a range of about 0.1% to 8% by weight, for example, 0.5% to 5% by weight, of one or more of polyvinyl alcohol, polyacrylic acid, and a polyvinyl alcohol-polyacrylic acid copolymer, and a range of about 0.2% to 10% by weight, for example, 0.5% to 5% by weight, of the additive. In the above-described range, the effect of the separator can be readily implemented.

In another example, the coating layer may include a third layer including the heat-resistant binder, the adhesive binder, the filler, and the additive.

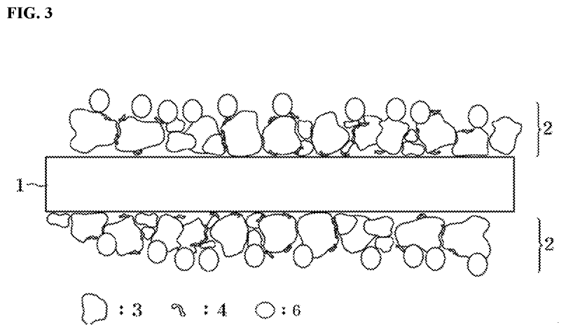

FIG. 3 is a cross-sectional view illustrating a separator according to one example embodiment. Referring to FIG. 3, the separator may include a porous substrate 1 and a coating layer 2 formed on the porous substrate 1, and the coating layer 2 may include a filler 3, a heat-resistant binder 4, an adhesive binder 6, and an additive (not shown in FIG. 3).

In one example, the coating layer may include a range of about 80% to about 99% by weight, for example, 90% to 99% by weight, of the filler, and a sum total in a range of about 1% to about 20% by weight, for example, 1% to 10% by weight, of the heat-resistant binder, the adhesive binder, and the additive. In the above-described range, the effect of the separator can be readily implemented.

The coating layer may have a thickness in a range of about 0.01 μm to about 20 μm, and may have a thickness in a range of about 1 μm to about 10 μm, or 1 μm to 5 μm, or 1 μm to 3 μm within the above-described range.

The coating layer may be formed by applying a composition for the coating layer on the porous substrate to a predetermined or desired thickness, and then aging the composition at a temperature in a range of about 85 °C to about 120 °C for about 15 hours or more, for example, a duration in a range of about 15 hours to about 24 hours.

### Porous Substrate:

The porous substrate may be or include a substrate having many pores that is generally used in electrochemical devices. The porous substrate may be or include, but is not limited to, a polymer film formed of or including any one polymer such as or including at least one of polyolefin such as polyethylene and polypropylene, a polyester such as polyethylene terephthalate and polybutylene terephthalate, a polyacetal, a polyamide, a polyimide, a polycarbonate, a polyetheretherketone, a polyaryletherketone, a polyetherimide, a polyamideimide, a polybenzimidazole, a polyethersulfone, a polyphenylene oxide, a cyclic olefin copolymer, a polyphenylene sulfide, a polyethylene naphthalate, glass fiber, Teflon, and polytetrafluoroethylene or a copolymer or mixture of two or more thereof.

The porous substrate may be, for example, a polyolefin-based substrate including a polyolefin, and the polyolefin-based substrate may have a desired or improved shutdown function, and thus may contribute to improving the safety of a battery. The polyolefin-based substrate may be or include at least one of, for example, a polyethylene single-layer film, a polypropylene single-layer film, a polyethylene/polypropylene double-layer film, a polypropylene/polyethylene/polypropylene triple-layer film, and a polyethylene/polypropylene/polyethylene triple-layer film. For example, the polyolefin-based resin may include a non-olefin resin in addition to an olefin resin, or may include a copolymer of an olefin and a non-olefin monomer.

The porous substrate may have a thickness in a range of about 1 μm to about 40 μm, for example, a thickness of 1 μm to 30 μm, 1 μm to 20 μm, or 5 μm to 15 am.

A separator according to one example embodiment may exhibit desired or improved air permeability, for example, the separator may have an air permeability value that is less than about 200 sec/100 cc, for example, less than or equal to 190 sec/100 cc or less than or equal to 180 sec/100 cc. In other words, the separator may have an air permeability value that is less than 40 sec/100 cc·1 μm per unit thickness, for example, less than or equal to 30 sec/100 cc·1 m or less than or equal to 25 sec/100 cc·1 μm. Here, the air permeability refers to the time (seconds) taken for 100 cc of air to penetrate a unit thickness of the separator. The air permeability per unit thickness may be obtained by measuring the air permeability for the entire thickness of the separator, and then dividing that air permeability by the thickness. The permeability may be measured as the time (seconds) taken for 100 cc of air to penetrate, using an air permeability measuring device (Asahi Seiko, EG01-55-1MR).

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be positioned between the positive electrode and the negative electrode.

### Positive Electrode

A positive electrode for a rechargeable lithium battery may include a current collector, and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free lithium nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0≤α≤2); LiₐNi_{1-b-c}Mn_{b}X_{c}O_{2-α}D_{α} (0.90≤a≤1.8, 0≤b≤0.5, 0≤c≤0.5, and 0≤α≤2); LiₐNi_{b}Co_{c}L¹_{d}GeO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof, X is or includes at least one of Al, Ni, Co, Mn, Cr, Fe, Mg, Sr, V, a rare earth element or a combination thereof; D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The positive electrode active material may be or include, for example, a high nickel-based positive electrode active material having a nickel content greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of the metal excluding lithium in the lithium transition metal composite oxide. The high-nickel-based positive electrode active material may be capable of realizing high capacity, and can be applicable to a high-capacity, high-density rechargeable lithium battery.

An amount of the positive electrode active material may be in a range of about 90 wt % to about 99.5 wt % based on 100 wt % of the positive electrode active material layer. Amounts of each of the binder and the conductive material may independently be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be or include graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in the form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

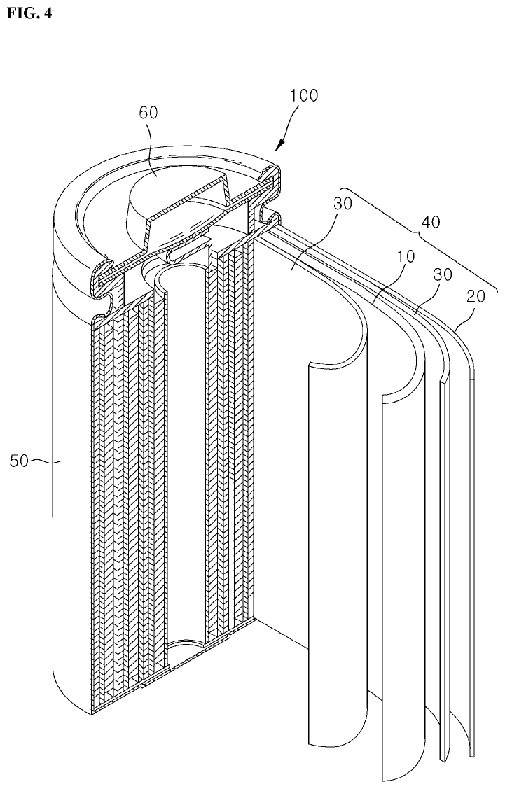

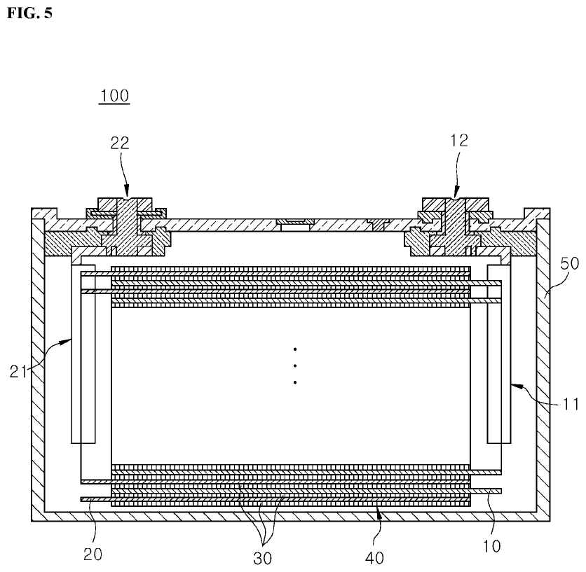

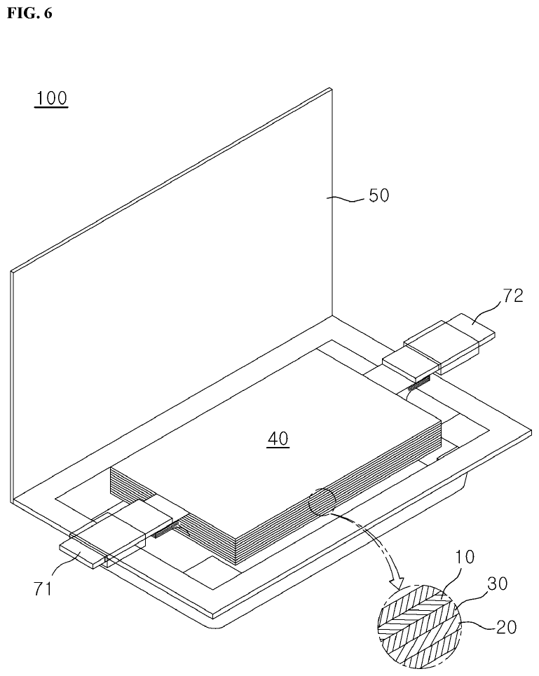

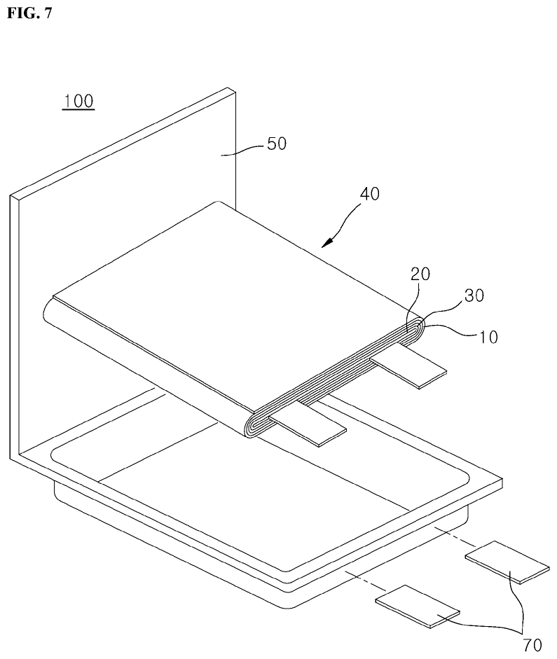

FIG. 4 to FIG. 7 are schematic views illustrating a rechargeable lithium battery according to an example embodiment. FIG. 4 shows a cylindrical battery, FIG. 5 shows a prismatic battery, and FIG. 6 and FIG. 7 show pouch-type batteries. Referring to FIG. 4 to FIG. 7, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 4. In FIG. 5, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 6 and FIG. 7, the rechargeable lithium battery 100 may include an electrode tab 70 illustrated in FIG. 7, or, for example, a positive electrode tab 71 and a negative electrode tab 72 illustrated in FIG. 6, the electrode tabs 70/71/72 forming an electric path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, examples and a comparative example of the present disclosure are described. However, the following examples are only examples of the present disclosure, and the present disclosure is not limited to the following examples.

### Preparation Example

To a 10 L four-necked flask equipped with a stirrer, a thermometer, and a condenser, distilled water (6,361 g), acrylamide (9.5 mol), potassium persulfate (0.01 mol), 2-acrylamido-2-methylpropanesulfonic acid (0.5 mol), and a 5 N lithium hydroxide aqueous solution (1.05 equivalents based on the total amount of 2-acrylamido-2-methylpropanesulfonic acid) are added, the internal pressure is reduced to 10 mmHg using a diaphragm pump, and the internal pressure is returned to normal pressure with nitrogen, and this operation is repeated three times.

The reaction is carried out for 12 hours while controlling the temperature of the reaction solution to be stabilized at a range of 65 °C to 70 °C. After cooling to room temperature, the pH of the reaction solution is adjusted to a range of 7 to 8 using a 25% ammonia aqueous solution.

Poly(acrylamide-co-2-acrylamido-2-methylpropanesulfonic acid)lithium salt was prepared in this manner. The molar ratio of acrylamide:2-acrylamido-2-methylpropanesulfonic acid was 95:5. About 10 mL of the reaction solution (reaction product) was taken, and the amount of nonvolatile component was measured, which was 9.5 wt % (theoretical value: 10 wt %).

### Example 1

The acrylic binder (10% by weight in distilled water) prepared in the preparation example and boehmite (particle size D50: 200 nm, plate-shaped) as a filler were mixed, and the resulting mixture was put into water as a solvent, milled at 25 °C for 30 minutes using a bead mill, and dispersed to prepare a dispersion.

TRX was added to the dispersion, and water was added so that the total solid content became 20% by weight, thereby preparing a composition for a first layer. The composition for a first layer included 95% by weight of boehmite, 4.5% by weight of the acrylic binder, and 0.5% by weight of TRX.

A composition for a second layer was prepared by mixing 95 parts by weight of poly(methyl methacrylate) (PMMA, particle-type aqueous binder), 4.5 parts by weight of polyvinyl alcohol-polyacrylic acid copolymer (PVA-PAA), and 0.5 parts by weight of TRX.

The composition for the first layer was applied to both surfaces of a polyethylene film (thickness: 8 μm, SK, air permeability: 120 sec/100 cc, puncture strength: 480 kgf) as a porous substrate to a thickness of 2 μm by a die-coating method and then dried and aged in an oven at 85 °C for 16 hours to manufacture a first layer. The composition for the second layer was applied on one surface of the first layer to a thickness of 0.5 μm, and then dried and aged in an oven at 85 °C for 16 hours to manufacture a separator.

### Examples 2 and 3 and Comparative Example 1

Separators were manufactured in the same manner as in Example 1, except that the components of each of the first layer and the second layer in Example 1 were changed as shown in Table 1 below.

### Manufacture of Battery

Lithium cobalt oxide (LCO, LiCoO) as a positive electrode active material, polyvinylidene fluoride as a binder, and carbon nanotubes (CNTs) as a conductive agent were mixed in a weight ratio of 98.7:0.9:0.4, respectively, and the resulting mixture was dispersed in N-methyl pyrrolidone to prepare a positive electrode slurry. The prepared positive electrode slurry was applied to one surface of a 10 μm-thick aluminum current collector using a reverse roll coater to a loading level (L/L) of 19.8 mg/cm² and then dried at 110 °C. The resulting positive electrode active material layer was rolled using a roll press to manufacture a positive electrode.

Artificial graphite as a negative electrode active material, styrene-butadiene rubber (SBR) as a binder, and carboxymethyl cellulose (CMC) as a thickener were mixed in a weight ratio of 97.5:1.5:1, respectively, and the resulting mixture was added to a water solvent to prepare a negative electrode slurry. The prepared negative electrode slurry was applied to both surfaces of a 10 m-thick copper foil using a reverse roll coater, and then dried at 120 °C. The resulting negative electrode active material layer was rolled with a roll press to manufacture a negative electrode.

The separator manufactured in the above-described examples and comparative examples was interposed between the positive electrode and negative electrode manufactured above, and then wound to manufacture an electrode assembly jellyroll. The jellyroll was inserted into a pouch, an electrolyte was injected, and the pouch was vacuum-sealed. The electrolyte used was 1.3 M LiPF₆ dissolved in a mixed solvent of ethylene carbonate (EC), propylene carbonate (PC), and propylene propionate (PP) in a volume ratio of 10:15:75 based on a total volume of 100. The jellyroll inserted into the pouch was pressed at a temperature of 80 °C for three minutes while applying a pressure of 11.7 kgf/cm² to manufacture a lithium rechargeable battery.

### Wet Adhesive Strength (Unit: N/25 mm)

Each separator of the examples and comparative examples was cut to a width of 25 mm and a length of 80 mm. The positive electrode manufactured as described above was cut to a width of 30 mm and a length of 80 mm. The positive electrode was placed on one surface of each separator, and the positive electrode was placed on the other surface to manufacture a unit cell.

The electrolyte (1.3 M LiPF₆ dissolved in a mixed solvent of EC, PC, and PP in a volume ratio of 10:15:75 based on a total volume of 100) was injected into a 10 cm×10 cm pouch, soaked for 12 hours, and then taken out, and bonding was performed under conditions of 80 °C and 300 kgf/cm for one hour. After the separator and the positive electrode were taken out of the pouch, the positive electrode and the separator were spread out 180°, and the force required to tear the positive electrode off the separator was measured using a tensile tester (Tinius Olsen, HT400).

Using the negative electrode manufactured as described above, the wet adhesive strength of the negative electrode was measured in the same manner as the wet adhesive strength for the positive electrode.

### Membrane Resistance (Unit: Q)

The membrane resistance was evaluated as electrochemical impedance spectroscopy (EIS) resistance. The separators manufactured in the examples and comparative examples were impregnated with an electrolyte, which was 1.3 M LiPF₆ dissolved in a mixed solvent of EC, PC, and PP in a volume ratio of 10:15:75 based on a total volume of 100, and the resulting separators were fitted onto an aluminum foil electrode with a lead tab and sealed in an aluminum pack to manufacture a test cell. The resistance (Q) of this test cell was measured at 20 °C by the AC impedance method (measurement frequency 100 kHz).

### Room-Temperature Lifetime (Unit: %)

A coin full cell was manufactured using the negative electrode, positive electrode, separator, and electrolyte manufactured above. As the electrolyte, 1.3 M LiPF₆ dissolved in a mixed solvent of EC, PC, and PP in a volume ratio of 10:15:75 based on a total volume of 100 was used.

With the manufactured rechargeable lithium battery, 200 charge/discharge cycles were performed under the conditions of 25 °C 1.0 C charge (CC/CV, 4.5 V 0.02 C cut-off)/1.0 C discharge (CC, 3.0 V cut-off) and then the battery characteristics were measured. The lifetime retention rate was calculated according to the following equation.

Lifetime retention rate (%)=(Discharge capacity after 200 cycles/initial discharge capacity)*100. Equation:
Room-temperature lifetime evaluation and thermal shrinkage rate after high-temperature storage (unit: %)

The room-temperature lifetime was evaluated in the same manner as described above. Thereafter the separator was taken out of the battery and cut into a size of 5 cm×5 cm to prepare samples. After allowing the samples to stand in an oven at 140 °C for one hour, the thermal shrinkage rate was calculated. The thermal shrinkage rate was calculated according to the following equation.

Thermal shrinkage rate=(L0−L1)/L0×100. Equation:

L0 is the initial area of the separator, and L1 is the area of the separator after being allowed to stand at 140 °C for one hour.

### Heat Exposure Evaluation

A pouch cell was manufactured using the negative electrode, the positive electrode, the separator, and the electrolyte manufactured above. The manufactured positive electrode was punched to a size of 3×4 cm, and the manufactured negative electrode was punched to a size of 3.2×4.2 cm. The separator was interposed between the positive electrode and the negative electrode, 1.3 M LiPF₆ dissolved in a mixed solvent of EC, PC, and PP in a volume ratio of 10:15:75 based on a total volume of 100 was used as an electrolyte, and the positive electrode, the separator and the negative electrode were sealed in aluminum pouches to manufacture pouch cells. The design capacity of the manufactured battery was 36 mAh.

The manufactured rechargeable lithium battery was exposed to a target temperature (high temperature) for one hour, and then the ignition was evaluated. When increasing the temperature from room temperature to the target temperature, the heating rate was maintained at 5 °C/min. Results were recorded as the number of ignited cells/number of evaluated cells and the number of non-ignited cells/number of evaluated cells.

TABLE 1

| | First | | | Second | | |
|---|---|---|---|---|---|---|
| | layer | | | layer | PVA- | |
| | Boehmite | Binder | TRX | PMMA | PAA | TRX |
| Comparative | 95 | 5.0 | 0 | 95 | 5.0 | 0 |
| Example 1 | | | | | | |
| Example 1 | 95 | 4.5 | 0.5 | 95 | 4.5 | 0.5 |
| Example 2 | 95 | 4.0 | 1.0 | 95 | 4.0 | 1.0 |
| Example 3 | 95 | 3.0 | 2.0 | 95 | 3.0 | 2.0 |

TABLE 2

| | Wet adhesive strength | | |
|---|---|---|---|
| | Positive | Negative | Membrane |
| | electrode | electrode | resistance |
| Comparative | 0.6 | 0.2 | 1.23 |
| Example 1 | | | |
| Example 1 | 0.8 | 0.4 | 1.15 |
| Example 2 | 1.0 | 0.6 | 1.06 |
| Example 3 | 1.1 | 0.7 | 1.00 |

TABLE 3

| | Room | | | | | |
|---|---|---|---|---|---|---|
| | temperature | | | | | |
| | lifetime | | | | | |
| | Lifetime | Thermal | Heat exposure | | | |
| | retention | shrinkage | 146 °C | | 148 °C | |
| | rate | rate | N | OK/F | N | OK/F |
| Comparative | 85.2 | 25 | 3 | 3/0 | 3 | 0/3 |
| Example 1 | | | | | | |
| Example 1 | 86.1 | 11 | 3 | 3/0 | 3 | 2/1 |
| Example 2 | 86.5 | 9 | 3 | 3/0 | 3 | 3/0 |
| Example 3 | 86.7 | 8 | 3 | 3/0 | 3 | 3/0 |

* N = Number of evaluated cells
* F = Ignited (Fail)
* OK = Not ignited

As shown in Tables 2 and 3 above, the separators of the examples can provide a low thermal shrinkage rate, a long room-temperature lifetime, and a long high-temperature lifetime by providing high wet adhesive strength. The separators of the examples can provide a long room-temperature lifetime and a long high-temperature lifetime by providing low membrane resistance. The separators of the examples can enhance the safety and reliability of batteries by reducing or suppressing ignition upon heat exposure of batteries having the separators.

The separator for a rechargeable lithium battery according to one example embodiment can provide a low thermal shrinkage rate, a long room-temperature lifetime, and a long high-temperature lifetime by providing high adhesive strength, particularly high wet adhesive strength. The separator for a rechargeable lithium battery according to one example embodiment can provide a long room temperature lifetime and a long high-temperature lifetime by providing low membrane resistance. According to one example embodiment, the separator for a rechargeable lithium battery can increase safety and reliability of batteries by reducing or suppressing ignition upon heat exposure of the batteries having the separator.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A separator for a rechargeable lithium battery, the separator comprising:
a porous substrate; and
a coating layer positioned on at least one surface of the porous substrate,
wherein the coating layer includes a binder and an additive, and the additive includes one or more of a compound of Chemical Formula 1, a compound of Chemical Formula 2, an oligomer thereof, and a polymer thereof: 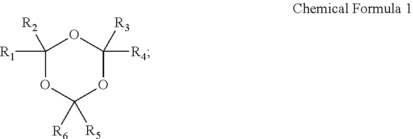
wherein R₁ to R₆ are each independently a hydrogen atom or a substituted or unsubstituted C1 to C10 alkyl group; and 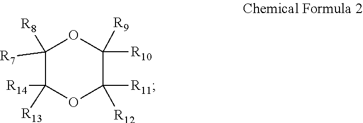
wherein R₇ to R₁₄ are each independently a hydrogen atom or a substituted or unsubstituted C1 to C10 alkyl group.

2. The separator of claim 1, wherein, in Chemical Formula 1, at least one of R₁ to R₆ is hydrogen.

3. The separator of claim 1, wherein the compound of Chemical Formula 1 comprises 1,3,5-trioxane (TRX) represented by Chemical Formula 1-1 below:

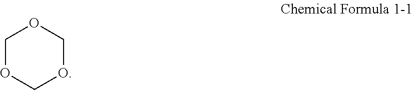

4. The separator of claim 1, wherein the oligomer and the polymer each comprises polyoxymethylene as a repeating unit.

5. The separator of claim 1, wherein one or more of the compound of Chemical Formula 1, the compound of Chemical Formula 2, the oligomer, and the polymer are included in the coating layer in an amount in a range of about 0.01% to about 10% by weight.

6. The separator of claim 1, wherein the binder comprises one or more of a heat-resistant binder and an adhesive binder.

7. The separator of claim 6, wherein the heat-resistant binder comprises one or more of a hydroxyl group, an amide group, a carboxylic acid group, a cyano group, a sulfonic acid group, a sulfonic acid salt group, and a sulfonate group.

8. The separator of claim 7, wherein the heat-resistant binder comprises:
a structural unit derived from (meth)acrylamide; and
a structural unit containing a sulfonic acid group, a sulfonic acid salt group, or a sulfonate group.

9. The separator of claim 6, wherein the adhesive binder comprises one or more of a hydroxyl group, an amide group, a carboxylic acid group, a cyano group, a sulfonic acid group, a sulfonic acid salt group, and a sulfonate group.

10. The separator of claim 6, wherein the coating layer further comprises a filler having a particle size D50 of about 0.7 μm or less.

11. The separator of claim 10, wherein the filler comprises a functional group capable of forming a hydrogen bond with the additive.

12. The separator of claim 6, wherein the coating layer comprises the heat-resistant binder, the additive, and the filler.

13. The separator of claim 6, wherein the coating layer comprises:
a first layer including the heat-resistant binder, the additive, and the filler; and
a second layer formed on the first layer and including the adhesive binder.

14. The separator of claim 6, wherein the coating layer comprises the heat-resistant binder, the adhesive binder, the additive, and the filler.

15. A rechargeable lithium battery comprising:
a positive electrode;
a negative electrode; and
a separator for the rechargeable lithium battery according to claim 1 between the positive electrode and the negative electrode.
